(19) United States
(12) Patent Application Publication
(10) Pub. No.: US 2013/0179319 A1
(43) Pub. Date: Jul. 11, 2013

(54) COMPOUND OVERNIGHT BANK RATE ACCRUAL FUTURES CONTRACT AND COMPUTATION OF VARIATION MARGIN THEREFORE

(71) Applicants: Peter Barker, Chicago, IL (US); James Boudreault, Palatine, IL (US); Daniel Grombacher, Evsanston, IL (US); Michael P. Kamradt, Flossmoor, IL (US); Frederick Sturm, Chicago, IL (US); John Labuszewski, Westmont, IL (US)

(72) Inventors: Peter Barker, Chicago, IL (US); James Boudreault, Palatine, IL (US); Daniel Grombacher, Evsanston, IL (US); Michael P. Kamradt, Flossmoor, IL (US); Frederick Sturm, Chicago, IL (US); John Labuszewski, Westmont, IL (US)

(21) Appl. No.: 13/348,251

(22) Filed: Jan. 11, 2012

(51) Int. Cl. G06Q 40/04

(52) U.S. Cl. 705/37

(57) ABSTRACT

The disclosed embodiments relate to an exchange-traded futures contract, guaranteed by a clearing house, and characterized by an embedded price dynamic comprising a compound accrual of a periodic interest rate up to a date on which trading therein is terminated, as specified in the futures contract terms and conditions. A trader may be allowed and/or enabled to take a position in a futures contract with respect to an interest bearing underlier with a variable interest rate and, thereby, minimize the number of transactions and attendant costs with respect to monitoring and correcting for divergences between the futures position and the notional interest rate swap exposure for which the futures position is intended to serve as a proxy. Variation margin for the position is computed based on an underlying reference interest rate as opposed to being computed solely on the basis of the end-of-business day price of the futures contract.

### BACKGROUND

A Futures Exchange, referred to herein also as an “Exchange”, such as the Chicago Mercantile Exchange Inc. (CME), provides a contract market where futures and options on futures are traded. Futures is a term used to designate all contracts for the purchase or sale of financial instruments or physical commodities for future delivery or cash settlement on a commodity futures exchange. A futures contract is a legally binding agreement to buy or sell a commodity at a specified price at a predetermined future time. An option is the right, but not the obligation, to sell or buy the underlying instrument (in this case, a futures contract) at a specified price within a specified time. The commodity to be delivered in fulfillment of the contract, or alternatively the commodity for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement. Cash Settlement is a method of settling a futures contract whereby the parties effect final settlement when the contract expires by paying/receiving the loss/gain related to the contract in cash, rather than by effecting physical sale and purchase of the underlying reference commodity at a price determined by the futures contract, price.

Typically, the Exchange provides for a “clearing house” through which all trades made must be confirmed, matched, and settled each day until offset or delivered. The clearing house is an adjunct to the Exchange, and may be an operating division of the Exchange, which is responsible for settling trading accounts, clearing trades, collecting and maintaining performance bond funds, regulating delivery, and reporting trading data. The essential role of the clearing house is to mitigate credit risk. Clearing is the procedure through which the Clearing House becomes buyer to each seller of a futures contract, and seller to each buyer and assumes responsibility for protecting buyers and sellers from financial loss due to breach of contract, by assuring performance on each contract. A clearing member is a firm qualified to clear trades through the Clearing House.

As an intermediary, the Exchange bears a certain amount of risk in each transaction that takes place. To that end, risk management mechanisms protect the Exchange via the Clearing House. The Clearing House establishes performance bonds (margins) for all Exchange products and establishes minimum performance bond requirements for customers of Exchange products. Performance bonds, also referred to as margins, are the funds that must be deposited by a customer with his or her broker, by a broker with a clearing member, or by a clearing member with the Clearing House, for the purpose of insuring the broker or Clearing House against loss due to breach of contract on open futures or options contracts. Performance bond is not a part payment on a purchase. Rather, performance bond helps to ensure the financial integrity of brokers, clearing members, and the Exchange. The Performance Bond to Clearing House refers to the minimum dollar deposit which is required by the Clearing House from clearing members in accordance with their positions. The initial margin is the total amount of margin per contract required by the broker when a futures position is opened. Maintenance, or maintenance margin, refers to a minimum amount, usually smaller than the initial performance bond, which must remain on deposit in the customer's account for any position at all times. A drop in funds below the maintenance margin level requires a deposit back to the initial margin level, i.e., a performance bond call. If a customer's equity in any futures position drops to or under the maintenance level because of adverse price action, the broker must issue a performance bond/margin call to restore the customer's equity. A performance bond call, also referred to as a margin call, is a demand for additional funds to bring the customer's account back up to the initial performance bond level whenever adverse price movements cause the account to go below the maintenance margin level. Within any given Exchange trading day, a futures contract position that is newly entered and cleared, and then held through the end of the trading day, is marked-to-market by the Exchange, i.e. the current market value, as opposed to the book value, is determined, from the trade price at which the contract position was entered to the trading day's end-of-day settlement price for the contract. Similarly, a futures contract position that is extant at the beginning of a given Exchange trading day, and that is then held through the end of the trading day, is marked-to-market by the Exchange from the previous day's end-of-day settlement price to the current day's end-of-day settlement price for the contract. In both cases, the net of these amounts is banked in cash. That is, if the mark-to-market records an increase in the price of the contract, the Clearing House credits to those clearing members holding open long positions, and debits from those clearing members holding open short positions, the pecuniary value of the change in contract price. If the mark-to-market records a decrease in the price of the contract, the Clearing House debits those clearing members holding open long positions, and credits to those clearing members holding open short positions, the pecuniary value of the change in contract price. Such credits to, or debits from, clearing member accounts at the Clearing-House are typically referred to as “variation margin.”

An interest rate futures contract, also referred to as an interest rate future, is a futures contract having an underlying instrument/asset that pays interest, for which the parties to the contract are a buyer and a seller agreeing to the future delivery of the interest bearing asset, or a contractually specified substitute. Such a futures contract permits a buyer and seller to lock in the price, or in more general terms the interest rate exposure, of the interest-bearing asset for a future date.

An interest rate swap (“IRS”) is a contractual agreement between two parties, i.e., the counterparties, where one stream of future interest payments is exchanged for another, e.g., a stream of fixed interest rate payments in exchange for a stream of floating interest rate payments, based on a specified principal amount. An IRS may be used to limit or manage exposure to fluctuations in interest rates. One common form of IRS exchanges a stream of floating interest rate payments on the basis of the 3-month London interbank offered rate for a stream of fixed-rate payments on the basis of the swap's fixed interest rate. Another common form of IRS, knows as an overnight index swap, exchanges at its termination a floating rate payment determined by daily compounding of a sequence of floating interest rates on the basis of an overnight interest rate reference (e.g., the US daily effective federal funds rate, or the European Overnight Index Average (EONIA)) over the life of the swap, for a fixed rate payment on the basis of daily compounding of the overnight index swap's fixed interest rate over the life of the swap.

An interest rate swap futures contract is one in which the underlying instrument is an interest rate swap. As such, an interest rate swap futures contract permits “synthetic” exposure to the underlying interest rate swap, i.e., without entailing actual ownership of the underlying IRS.

Existing systems for providing interest rate swap futures contracts utilize standardized commodity futures contracts that enable acquisition or shedding of synthetic interest rate swap exposure. Examples include:

| | Floating Rate Option for Interest |
|---|---|
| | Rate Swap Serving as Futures |
| Futures Contract | Contract's Notional Reference |
| CBOT Interest Rate Swap | 3-month USD BBA LIBOR |
| NYSE Liffe Euro Swapnote | 6-month EURIBOR |
| NYSE Liffe US Dollar Swapnote | 3-month USD BBA LIBOR |

Unlike the various interest rate swaps whose rate exposures they reference, such commodity futures contracts are limited by their inability to “roll down the curve.” That is, the term-to-maturity exposure impounded in any such futures contract cannot and does not shorten naturally with the passage of time, necessitating that a trader must periodically enter into new contracts to replace expiring contracts in order to maintain a long term position.

For example, a CBOT 10-Year Interest Rate Swap future expires, by cash settlement, with reference to the fixed rate for a par-valued 10-year US dollar interest rate swap. Upon determination of its final settlement price, the futures contract ceases to exist.

This structural feature poses two related challenges for any market participant who uses such futures for the purpose of maintaining synthetic exposure to an interest rate swap. First, she must incur the cost of rolling her position. That is, she must replace the position in the expiring contract with a successor position in futures for the next following delivery month. Moreover, she must do the same at every futures expiration during the term of the swap rate exposure that she aims to synthesize.

Second, in pursuing this course, she incurs increasing amounts of basis risk, i.e. the risk that the values of offsetting investments, as part of a hedging strategy, will not respond to a given movement in market interest rates in entirely opposite directions or magnitudes from each other, and will thereby create a potential for excess gains or losses. To see this, consider again the example of CBOT 10-Year Interest Rate Swap futures, for which the underlying reference is the fixed interest rate on a par 10-year US dollar interest rate swap that exchanges a stream of floating interest rate payments on the basis of the 3-month London interbank offered rate for a stream of fixed-rate payments on the basis of the swap's fixed interest rate. At initial entry of the futures position, the market participant uses this contract as a proxy for a 10-year interest rate swap exposure. In rolling from the expiring futures into futures for the next following (quarterly) delivery month, the market participant is using a futures contract for 10-year swap rate exposure as a proxy for a notional interest rate swap with approximately 9.75 years of remaining term to maturity. Successive quarterly futures expirations exacerbate such basis risk. For instance, two years following the initial entry of the futures position, the market participant finds herself using futures for 10-year swap rate exposure as a proxy for a notional interest rate swap with approximately eight years of remaining term to maturity.

Synthetic interest rate swap exposure may be achieved instead through use of interest rate futures that directly reference the short-term interest rate that serves as the floating rate option for the interest rate swap. Examples of such short-term interest rate (“STIR”) futures include CBOT 30-Day Fed Funds futures, CME 1-Month Eurodollar futures, 3-Month Eurodollar futures, or 3-Month Overnight Interest Rate Swap (“OIS”) futures, and NYSE Liffe Eonia futures, Eonia Swap Index futures, or Short Sterling futures.

The market participant may construct a futures proxy for the desired interest rate swap exposure with strips of such futures, i.e., sequences of STIR futures contracts with consecutive delivery months. For example, a market participant might use CME 3-month Eurodollar futures in each of the nearest 40 quarterly delivery months, in varying quantities, to synthesize a 10-year US dollar interest rate swap. Similarly, varying amounts of CBOT 30-Day federal funds futures for each of the nearest 12 monthly delivery months might be combined to create a synthetic proxy for a 1-year US dollar overnight index swap.

This alternative solution, described above, of using interest rate futures that directly reference the short-term interest rate that serves as the floating rate option for the interest rate swap, poses several practical challenges. First, the array of futures delivery months that the exchange lists for trading may be too limited to permit the creation of synthetic proxies for interest rate swap exposures other than those with relatively short terms to maturity. For instance, given that NYSE Liffe's listing of Euribor futures extends to 28 quarterly delivery months, the scope for using these futures to create proxies for euro interest rate swap exposures is constrained to swap terms to maturity of seven years or less.

Second, to the extent that liquidity pools supporting STIR futures contracts tend to become increasingly shallow and narrow for increasingly remote delivery months, one's ability to use such futures to manufacture proxies for interest rate swap exposures, in adequate size, may be limited to an even shorter range of terms to maturity.

Third, using STIR futures to synthesize the financial exposure of an interest rate swap almost surely entails many transactions instead of one or a few. Compared to a transaction in a corresponding swap futures contract or in the interest rate swap itself, a STIR futures proxy structure is apt to be unattractively expensive in terms of execution slippage cost, exchange trading fees, and brokerage charges.

U.S. Pat. No. 6,304,858, to Mosler et al., addresses the problem with existing systems which use standard commodity futures contracts, described above, by proposing a suite of interest rate swap futures with terms to maturity in quarterly increments, such that an open position in a first futures contract, which references a given interest rate term to maturity and which is nearing its termination of trading, automatically rolls into a similarly scaled position in a second futures contract, for the next following delivery month and for which the reference interest rate term to maturity is shorter than the corresponding measure for the first futures contract by an interval equal to the span between the two futures delivery months.

For instance, in a hypothetical implementation of this mechanism, an expiring 10-year US interest rate swap future would automatically roll into a corresponding position in a 9.75-year interest rate swap future for delivery three months hence. After another three months have elapsed, the position in the 9.75-year interest rate swap futures would be nearing expiration. The holder of this position would automatically roll into a corresponding position in a 9.5-year interest rate swap future for delivery another three months hence, and so on.

Bolsa de Mercadorias e Futuros (now BVMF) lists a suite of Daily Interest (“DI”) futures listed for trading by the Brazilian futures exchange, which implicitly takes a different approach to addressing the problem with existing systems which use standard commodity futures contracts, as described above. The salient features of the BVMF DI futures contract are as follows:

Value Basis: Contract value is in terms of points, with par equal to 100 points. At termination of trading, a DI futures contract's value is required to equal 100 points. On any date prior to termination of trading, contract value represents market participants' assessment of the present value, on that day, of 100 points of contract equity for notional receipt on the bank business day following the contract's last trading day.

Contract reference: The underlying reference from which any DI futures contract derives is a daily sequence of values of the Average One-Day Interbank Deposit Rate (the DI Rate) calculated and published daily by CETIP, a publicly-held Brazilian company that offers registration, custody, trading and settlement of assets and securities. The CETIP interbank deposit is a financial instrument that enables short-term funding transactions among financial institutions. CETIP publishes the DI rate on each Brazilian financial market business day.

Pricing engine: Contract value is linked to daily values of the DI rate as follows:

P₁=100×Eₜ[Π_{i=0 . . . M-1}(1+rₜ₊ᵢ/100)^{-bi/252}]
where
Pₜ contract value, in price points, on day t
Eₜ[•] the representative market participant's expectation of the bracketed term, conditional upon information available as of day t
Π( . . . ) product operator where, eg, Π(n₁, n₂, n₃)=n₁×n₂×n₃
M number of BVMF Exchange business days from Day t to the contract's termination of trading
bi the number of Reserves between the two BVMF Exchange business days that follow Day t by i and i+1 Exchange business days, respectively. A Reserve is defined in the DI futures contract terms and conditions to be “a business day for, the purpose of operations performed on the financial market, pursuant to the provisions established by the National Monetary Council” of Brazil. To the extent that the BVMF Exchange and the National Monetary Council observe the same schedule of business days, bi's value is typically 1.
rₜ₊ᵢ value of the DI Rate that will apply to a CETIP interbank deposit for settlement on Day t+i and for maturity on the next following Reserve.

Price quotation: On any given Day t, contract price is quoted in terms of the interest rate per annum, ρₜ that produces contract value Pₜ:

Pₜ=100×((1+ρₜ/100)^{1/252})^{-M}

(To lighten notation, we assume that M, the number of BVMF Exchange business days within the interval from Day t until termination of trade in the contract, is equal to the number of National Monetary Council Reserves within the same interval.)

The minimum price increment is 1/10th of one basis point per annum for the nearest three contract expirations and one basis point per annum for all other contracts.

Contract notional size: At termination of trade in a DI futures contract, the contract value is Brz 1,000 per price point, or Brz 100,000 per contract.

### BRIEF DESCRIPTION OF THE DRAWINGS

FIG. 1 shows a block diagram of an exemplary network for trading futures contracts, according to one embodiment.

FIG. 2 a block diagram of an exemplary implementation of the system of FIG. 1 for administering futures contracts, according to one embodiment.

FIG. 3 depicts a flow chart showing operation of the system of FIGS. 1 and 2.

FIG. 4 shows an illustrative embodiment of a general computer system 400 for use with the system of FIG. 1.

### DETAILED DESCRIPTION

The disclosed embodiments relate to an exchange-traded futures contract, guaranteed by a clearing house, and characterized by an embedded price dynamic comprising a compound accrual of a periodic short-term (e.g., daily, weekly, monthly or any other regular period) interest rate up to a date on which trading in the futures contract is terminated, as specified in the futures contract terms and conditions. More particularly, a trader, referred to also as the position holder, may be allowed and/or enabled to take a position in a futures contract with respect to an interest bearing underlier with a variable interest rate and, thereby, minimize the number of transactions and attendant costs with respect to monitoring and correcting for divergences between the futures position and the notional interest rate swap exposure for which the futures position is intended to serve as a proxy. In particular, the term to maturity of the interest rate exposure underlying the futures contract shortens naturally and automatically over time, which avoids divergence between the futures contract rate and the forward interest rate exposure in the contract's underlier. Variation margin, i.e. the credit or debit to the margin account of the position holder based on the difference in mark-to-market for the current period from the mark-to-market for the prior period to account for any change in market value, for the position in the futures contract is computed on the basis of an underlying reference interest rate, i.e., a credible third party daily valuation, such as an overnight interbank loan rate promulgated by a central bank, as opposed to being computed solely on the basis of the end-of-business day price of the futures contract.

In one embodiment, the disclosed futures contract is referred to as a Compound Overnight Bank Rate Accrual (“COBRA”) futures contract. The mechanism of the COBRA futures contract, as will be described, directly addresses the chief problem with existing systems for acquiring or shedding of synthetic interest rate swap exposure, as described above. It furnishes the user with an interest rate future in which the term to maturity of the interest rate exposure that serves as the contract's underlying reference shortens naturally with the passage of time. Specifically, on any given trading day the future interest rate exposure that serves as the underlying reference for a COBRA futures contract is the notional fixed rate that:
(i) applies to the interval spanning from such trading day to the termination of trading in the contract, and
(ii) is financially equivalent to compound accrual, over the future time interval defined in (i), of the interest rate measure that serves as the contract reference.

It will be appreciated that the disclosed embodiments may complement other interest rate products which may serve as the underlier therefore. Daily Effective Federal Funds Rate (“FF”) or Eonia implementations of the COBRA mechanism may make useful ancillaries to Libor-reference and EURIBOR-reference IRS (including, e.g., CME Cleared IRS) that are subject to Overnight Interest Rate Swap (“OIS”) valuation. Further, an overnight BBA Libor implementation may fill the need for “stub rate” futures to use in conjunction with combinations of CME Eurodollar futures that are constructed to serve as proxies for the interest rate exposures in interest rate swaps, as described above.

The COBRA futures contract structure would also conduce to rich arrays of expiration days that coincide with key periodic dates in both established futures markets and cash government bond markets (e.g., IMM dates to match Eurodollar and/or Euribor futures, month-end and/or 15th of month to match Treasury Note and Bond coupon and maturity dates, first business days and/or last business days of Treasury futures delivery months).

The COBRA futures contract provides trading cost efficiency by embedding, in the price dynamics of a single futures contract, the compound accrual of a daily interest rate up to a terminal date certain, specified in the contract terms and conditions as the contract's termination of trading. To the extent that the COBRA futures contract thereby circumvents the practical challenges posed by alternative solutions described above, it enables the futures position holder to save time and effort that would otherwise be spent in monitoring divergences between a futures position, and the notional interest rate swap exposure for which the futures position is intended to serve as a proxy. For the same reason, it enables the futures position holder to conserve transaction fees that might otherwise be paid out by way of mid-course position adjustments to rectify such divergences.

In addition, by design, there is either little or no differential in the yield-to-price mapping as between a COBRA futures contract and a corresponding overnight index swap. Thus COBRA futures contracts—even those with remote expiration dates—do not require the user to estimate convexity bias resulting from using futures contract rates to price swaps as a substitute for forward rates. Convexity bias relates to the expected volatility of the contract reference interest rate, and typically causes divergence between a STIR futures contract rate to and the forward interest rate that serves as the contract's underlying reference.

In particular, the disclosed embodiments relate to the design of a futures contract for which the underlying reference interest rate is a floating or variable interest rate, wherein periodic marks-to-market are made with direct reference to the underlying reference interest rate, as would be performed at final settlement, rather than being made solely with reference to the prevailing contract price, as is done with traditional futures contracts. In embodiments featuring daily compounding of an underlying reference overnight interest rate, each day's mark-to-market would be made with direct reference to this underlying reference overnight interest rate; examples include, aside from the US daily effective federal funds rate, EU EONIA, UK SONIA, Brazil SELIC, Brazil CETIP, Japan TIBOR, BBA overnight LIBOR, as will be described. In embodiments featuring weekly compounding of an underlying reference weekly interest rate, a mark-to-market on every seventh calendar day would be made with direct reference to this underlying reference weekly interest rate; examples include the European Central Bank 1-week Main Refinancing Operations Rate, BBA 1-week LIBOR, 1-week Euribor, or JBA 1-week TIBOR.

In one embodiment, the disclosed futures contract is referred to as a Compound Overnight Bank Rate Accrual (COBRA) futures contract. While the disclosed futures contract will be discussed with reference to the COBRA futures contract, it will be appreciated that the disclosed mechanisms may be applicable to any futures contract wherein periodic marks-to-market are performed with reference to the value of the underlier, e.g. a variable interest bearing asset, rather than solely with reference to the value of the futures contract itself, as described herein.

The distinguishing feature of the disclosed futures contract, such as the COBRA futures contract, is that each day's mark-to-market possesses the significance of a final settlement—“final” in the sense that it is determined on the basis of the contract's underlying reference interest rate. Specifically, for any two sequential exchange business days, Day₀ and Day₁, the mark-to-market for a COBRA contract position held on or before daily close on Day₀ through daily close on Day₁ would be computed as:
(i) daily settlement value for Day₁
   minus
(ii) contract equity that obtains if contract reference interest rate for Day₀ is applied to contract daily settlement value for Day₀, for a term of one business day (ie, through Day₁).

The disclosed futures contract, such as the COBRA futures contract, may be summarized in terms of five characteristics common to any standardized futures contract: the basis for gauging contract value, the contract's underlying reference, the pricing engine, the mode of price quotation, and notional size.

Value basis: In one embodiment, the contract value is specified in terms of points, with par equal to 100 points, and at termination of trading in the contract its value is required to equal 100 points. On any date prior to termination of trading, contract value represents market participants' assessment of the present value, on that day, of 100 points of contract equity for notional receipt on the bank business day following the contract's last trading day.

Contract reference: In one embodiment, the reference from which the contract derives is a daily sequence of values of a given overnight interest rate, such that the last member of the sequence is for the last day of trading in the contract. In this embodiment, candidates for contract reference interest rate would potentially include, but would not be limited to, benchmark measures of domestic overnight interbank loan rates produced by various central banks, such as:
daily effective federal funds (FF) rate published by Federal Reserve Bank of New York,
Eurozone overnight index average (Eonia) published by the European Central Bank,
the central securities depository rate for Sistema Especial de Liquidação e Custodia (the SELIC rate) published by Banco Central do Brasil, or
the Average One-Day Interbank Deposit Rate (the CETIP or DI rate) calculated and published daily by CETIP, a publicly-held Brazilian company that offers registration, custody, trading and settlement of assets and securities.

In this embodiment, candidates for contract reference interest rate also would potentially include, but would not be limited to overnight interbank loan rate measures published by bank or brokerage industry associations, such as:
overnight BBA LIBOR sponsored by the British Bankers'Association,
sterling overnight index average (Sonia) sponsored by Wholesale Market Brokers' Association, or
the overnight Tokyo Interbank Average Rate (TIBOR) sponsored by Zenginkyo, the Japan Bankers' Association.

Pricing engine: In one embodiment, the contract value may be linked to daily values of contract reference interest rate according to one of at least two conventions: Exact Pricing or Simplified Pricing.

Exact Pricing: Under the Exact Pricing convention, the contract reference interest rate is assumed to compound over each business day, with simple interest accrual over intervening weekend days and holidays. This convention resembles the scheme that customarily applies in over-the-counter (“OTC”) markets for overnight index swaps, or in open overnight repurchase agreements in various government securities markets, or in open overnight interbank deposits.

For, e.g., FF, Eonia, USD BBA overnight LIBOR

Pₜ=100×Eₜ[Π_{i=0 . . . m-1}(1+(dₜ₊ᵢ/360)×(rₜ₊ᵢ/100))⁻¹]

For, e.g., Sonia, STG BBA overnight LIBOR, JPY BBA overnight LIBOR

Pₜ=100×Eₜ[Π_{i=0 . . . m-1}(1+(dₜ₊ᵢ/365)×(rₜ₊ᵢ/100))⁻¹]
where
Pₜ contract value on day t
Eₜ[•] the representative market participant's expectation of the bracketed term, conditional upon information available as of day t
Π( . . . ) product operator where, eg, Π(n₁, n₂, n₃)=n₁×n₂×n₃
m number of business days from day t to the contract's termination of trading
dₜ number of calendar days between Day t and the next following business day. For example, during a non-holiday week, if Day t is a Thursday, then dₜ=1, the number of calendar days between Thursday and the following Friday, whereas if Day t is a Friday, then dₜ=3, the number of calendar days between Friday and the following Monday r, value of the contract reference interest rate that will apply to a bank deposit for settlement on Day t and for maturity on the next following business day.

Simplified Pricing: An alternative design simplifies the relationship between the contract value and the contract reference interest rate by positing compounding of interest over each calendar day.

For, eg, FF, Eonia, USD overnight BBA LIBOR

Pₜ=100×Eₜ[Π_{i=0 . . . M-1}(1+(1/360)×(rₜ₊ᵢ/100))⁻¹]

For, eg, Sonia, STG BBA overnight LIBOR, JPY BBA overnight LIBOR

Pₜ=100×Eₜ[Π_{i=0 . . . M-1}(1+(1/365)×(rₜ₊ᵢ/100))⁻¹]
where all notation is as described above, except for:
M number of days from Day t to the contract's termination of trading

Price quotation: In one embodiment, the contract price may be quoted in terms of either price points or contract rate. For example, the contract price may be quoted directly in terms of price points, i.e., number of points of contract value as defined above. The minimum price increment may then be a contractually stipulated fraction of one price point, e.g., 1/100th, 1/1000th, or ¼ of 1/100^{th} of a price point. Alternatively, the contract price is quoted in terms of the interest rate per annum that produces the contract value defined above. Such a contract rate is assumed to apply to a notional bank deposit for same-day settlement, for maturity on the business day following the contract's last day of trading. The minimum price increment is in terms of interest rate percent per annum and fractions thereof, e.g., one basis point, 1/10th of one basis point, ⅛th of one basis point per annum.

If the contract pricing engine observes the Exact Pricing convention defined above, then at any given time t the contract interest rate that serves as the basis for price quotation is the value, ρₜ, that equates the pricing expression to the contract's value at time t in terms of points, Pₜ

For, e.g., FF, Eonia, USD BBA overnight LIBOR

Pₜ=100×Π_{i=0 . . . m-1}(1+(dₜ₊ᵢ/360)×(ρₜ/100))⁻¹

For, e.g., Sonia, STG BBA overnight LIBOR, JPY BBA overnight LIBOR

Pₜ=100×Π_{i=0 . . . m-1}(1+(dₜ₊ᵢ/365)×(ρₜ/100))⁻¹

Likewise, if the contract pricing engine observes the Simplified Pricing convention defined above, then the contract rate that serves as the basis for price quotation is the value, ρₜ that equates the pricing expression to the contract value in terms of price points, Pₜ.

For, e.g., FF, Eonia, USD BBA overnight LIBOR

Pₜ=100×(1+(1/360)×(ρₜ/100))^{-M}

For, e.g., Sonia, STG BBA overnight LIBOR, JPY BBA overnight LIBOR

Pₜ=100×(1+(1/365)×(ρₜ/100))^{-M}

A useful feature of Simplified Pricing is that it enables convenient closed-form conversion from contract value in price points, Pₜ, to contract rates, ρₜ, and back.

For, e.g., FF, Eonia, USD BBA overnight LIBOR

ρₜ=100×360×((100/Pₜ)^{1/M}−1)

For, e.g., Sonia, STG BBA overnight LIBOR, JPY BBA overnight LIBOR

ρₜ=100×365×((100/Pₜ)_{1/M}−1)

The quid pro quo for this convenience is that Simplified Pricing is an approximation to, not an exact replication of, the valuation schemes that are familiar to OTC OIS users. The Simplified Pricing convention will always produce a rate-to-value mapping that is a bit more convex (and never less convex) than for either the Exact Pricing convention or the corresponding OTC OIS. In environments with high and/or volatile short-term interest rates, this may be regarded by market participants as either a source of unappealing hedge ineffectiveness or as a potentially attractive source of relative-value trading opportunities.

Contract notional size: Contract size is determined by the value of one contract price point. Familiar examples include $1,000 per price point ($100,000 per contract) as for CBOT Treasury futures, or $10,000 per price point ($1 million per contract) as for CME Eurodollar futures. In examples below, contract notional size is $5,000 per price point ($500,000 per contract).

In an exemplary embodiment, the disclosed futures contract may comprise an FF COBRA futures contract that references the daily effective federal funds (“FF”) rate, that is, the underlier is the US daily effective federal funds rate. This represents, for each day, a transaction-weighted average of that day's transactions in the market for US domestic overnight interbank placements of immediately available funds. It will be appreciated that the federal funds (“FF”) rate is itself an interest rate, as opposed to a swap that derives from a reference interest rate. It will be further appreciated that other underliers may be used as was described above for the contract reference.

By design the final settlement price will be 100 points and the contract size may be assumed to be, for this example, $5,000 per point, or $500,000 per contract.

Consider such a hypothetical contract for delivery in June 2013, as traded on 2 May 2011. Assume the contract terminates trading on 18 Jun. 2013 (Tue before 3rd Wed of expiration month), with expiration and final settlement on 19 Jun. 2013 (3rd Wed of expiration month). The interval from trade date to final settlement date spans 779 days (approximately 2 years 1½ months).

Under the Exact Pricing convention described above, the relationship between contract value P and contract rate ρ is:

P=100/{(1+(1/360)(ρ/100))⁴²¹×(1+(2/360)(ρ/100))⁵×(1+(3/360)(ρ/100))⁹⁶×(1+(4/360)(ρ/100))¹⁵}

The contract pricing engine is “exact” in the sense that compounding of interest provides explicitly for intervals during the life of the contract when interest will accumulate in simple rather than compound terms. That is, of the total 779-day interval from trade date to last day of trading, the contract rate is assumed to accumulate in simple terms over 358 days, comprising:
two-day intervals in five instances (two Thanksgivings, one New Year's Day, one Independence Day, and one Christmas);
three-day intervals in 96 instances (chiefly weekends), and
four-day intervals in 15 instances (primarily holidays that result in long weekends).
   As such, it hews to conventions observed in the market for open overnight placements in the US interbank federal funds, as well as in OTC markets for Eonia, FF, or Sonia OIS.

### Example 1

Suppose the contract price is quoted in terms of contract rate as defined above, with a minimum price increment of 1/10^{th} of one basis point per annum. Assume a market participant purchases the contract at a price of 5.050 percent. Assume the daily settlement price for the same trading session is 5.000 percent. Determination of mark-to-market proceeds as follows:

$$\begin{matrix}Trade Price = 5.050 -> Contract Value \\ = 89.63962 points \\ = 100 / \{ \begin{matrix}{( 1 + ( 1 / 360 ) ( 5.05 / 100 ) )}^{421} \times \\ {( 1 + ( 2 / 360 ) ( 5.05 / 100 ) )}^{5} \times \\ {( 1 + ( 3 / 360 ) ( 5.05 / 100 ) )}^{96} \times \\ {( 1 + ( 4 / 360 ) ( 5.05 / 100 ) )}^{15}\end{matrix} \}\end{matrix}$$

$$\begin{matrix}Daily Settlement Price = 5.000 -> Contract Value \\ = 89.74665 points \\ = 100 / \{ \begin{matrix}{( 1 + ( 1 / 360 ) ( 5 / 100 ) )}^{421} \times \\ {( 1 + ( 2 / 360 ) ( 5 / 100 ) )}^{5} \times \\ {( 1 + ( 3 / 360 ) ( 5 / 100 ) )}^{96} \times \\ {( 1 + ( 4 / 360 ) ( 5 / 100 ) )}^{15}\end{matrix} \}\end{matrix}$$

$$\begin{matrix}Mark \text{-} to \text{-} Market = 0.09703 points \\ = 89.74665 points minus 89.64962 points\end{matrix}$$

Futures buyer collects, and seller pays, variation margin equal to:

$485.15=0.09703 points×$5,000 per point.

### Example 2

Suppose instead that the contract price is quoted directly in terms of price points as described above, with a minimum price increment of one quarter of 1/100^{th} of a price point, equal to $12.50 per contract. Assume that market participants fundamentally value the futures contract as in the above example, with the only difference being that the contract is quoted in terms of price points, subject to the above-mentioned constraint on minimum price increments:
Trade Price=89.6500 points
Daily Settlement Price=89.7475 points
Mark-to-Market=0.0975 points=89.7475 points minus 89.6500 points
Futures purchaser collects, and seller pays, variation margin equal to $487.50=0.0975 points×$5,000 per point.

### Example 3

Assume the buyer of the contract on 2 May decides to hold their open position through close of trading the following day, 3 May. Assume moreover that the contract price is quoted in terms of the contract interest rate as in [0047], with the daily settlement price on 3 May equal to 5.010 percent, versus the daily settlement price of 5.000 percent on 2 May. Under the Exact Pricing convention described above, and with prices quoted in terms contract interest rate as described above, the contract daily settlement price on 3 May is re-expressed in price point terms in the same fashion as on 2 May:

Daily Settlement Price=5.010→Contract Value=89.73972 points 100/{(1+(1/360)(5.01/100))⁴²⁰×(1+(2/360)(5.01/100))⁵×(1+(3/360)(5.01/100))⁹⁶×(1+(4/360)(5.01/100))¹⁵}

Even if the contract interest rates that signify daily settlement prices for 2 May and 3 May were identical, the respective contract settlement values would differ, because the term to expiry has shortened to 778 days from 779 days. In this particular example, the number of one-day intervals over which compounding occurs is reduced to 420 from 421.

The futures position mark-to-market is assessed with reference to the previous day's FF rate (for Monday, 2 May), as published by the Federal Reserve Bank of New York on the following morning (Tuesday, 3 May), as follows:
(i) daily settlement value for 3 May minus
(ii) contract settlement value that would obtain if the true FF rate for 2 May were applied to the contract daily settlement value for 2 May, for a term of one business day.

### Example 4

Assume the daily effective federal funds rate for 2 May is 0.09 percent per annum. Then,

$$\begin{matrix}Mark \text{-} to \text{-} Market = - 0.00715 points \\ = ( 3 May Settlement Price ) minus \\ ( 1 + ( 1 / 360 ) ( 0.09 / 100 ) ) \times ( 2 May Settlement Price ) \\ = 89.73972 points minus \\ ( 1 + ( 1 / 360 ) ( 0.09 / 100 ) ) \times 89.74665 points \\ = 89.73972 points minus 89.74687 points\end{matrix}$$

Long open interest holders pay, and short open interest holders collect, variation margin per contract equal to $35.75, equal to 0.00715 points×$5,000 per point.

### Example 5

Suppose the contract price is quoted directly in terms of price points as in Example 2 above. Suppose as before that both contract price quotes and daily settlement prices are made in minimum increments of one quarter of 1/100^{th} of a price point, equal to $12.50 per contract. Then daily settlement prices are set as follows:
2 May=89.7475 points
3 May=89.7400 points
The mark-to-market for the open position is computed as:

$$\begin{matrix}Mark \text{-} to \text{-} Market = - 0.00772 points \\ = ( 3 May Daily Settlement ) minus \\ ( 1 + ( 1 / 360 ) ( 0.09 / 100 ) ) \times ( 2 May Daily Settlement ) \\ = 89.7400 points minus \\ ( 1 + ( 1 / 360 ) \times ( 0.09 / 100 ) ) \times 89.7475 points \\ = 89.7400 points minus 89.74772 points\end{matrix}$$

Long open interest holders pay, and short open interest holders collect, variation margin per contract equal to $38.60, equal to 0.00772 points×$5,000 per point

Under the Simplified Pricing convention described above, the relationship between contract price P and contract interest rate ρ reduces to:

P=100/(1+(1/360)(ρ/100))⁷⁷⁹

The contract rate is assumed to compound each calendar day, including workdays, weekend days, and holidays alike, contrary to either money market practice or conventions observed in the OTC markets for OIS in, e.g., Eurozone, UK, or US.

### Example 6

Suppose price is quoted in terms of the contract rate, with a minimum price increment of 1/10^{th} of one basis point per annum. Assume a market participant purchases the contract at a price of 5.050 percent. Assume the daily settlement price for the same trading session is 5.000 percent. Determination of the mark-to-market will proceed as follows:

$$\begin{matrix}Trade Price = 5.050 -> Contract Value \\ = 89.64895 points \\ = 100 / {( 1 + ( 1 / 360 ) ( 5.05 / 100 ) )}^{779}\end{matrix}$$

$$\begin{matrix}Daily Settlement Price = 5.000 -> Contract Value \\ = 89.74598 points \\ = 100 / {( 1 + ( 1 / 360 ) ( 5 / 100 ) )}^{779}\end{matrix}$$

$$\begin{matrix}Mark \text{-} to \text{-} Market = 0.09703 points \\ = 89.74598 points minus 89.64895 points\end{matrix}$$

Futures buyer collects, and seller pays, variation margin equal to:

$485.15=0.09703 points×$5,000 per point.

### Example 7

Suppose instead the contract price is quoted directly in terms of price points as described above, with a minimum price increment of one quarter of 1/100^{th} of a price point, equal to $12.50 per contract. Applying this restriction to the prices in the above example produces the following results:
Trade Price=89.6500 points
Daily Settlement Price=89.7450 points
Mark-to-Market=0.0950 points=89.7450 points minus 89.6500 points
Futures purchaser collects, and seller pays, variation margin equal to:

$475=0.0950 points×$5,000 per point.

### Example 8

Assume as in Example 6, above, that contract price is quoted in terms of contract interest rate, and assume that the buyer of the contract on 2 May holds her open position through close of trading the following day, 3 May, and that daily settlement prices on 2 May and 3 May are 5.000 percent and 5.010 percent, respectively. Under the Simplified Pricing convention described above, and with prices quoted in terms contract interest rate as described above, these contract daily settlement prices may be re-expressed in price point terms as follows:

$$\begin{matrix}2 May Daily Settlement Price = 5.000 -> Contract Value \\ = 89.74598 points \\ = 100 / {( 1 + ( 1 / 360 ) ( 5 / 100 ) )}^{779}\end{matrix}$$

$$\begin{matrix}3 May Daily Settlement Price = 5.010 -> Contract Value \\ = 89.73905 points \\ = 100 / {( 1 + ( 1 / 360 ) ( 5.01 / 100 ) )}^{778}\end{matrix}$$

As before, the futures mark-to-market is assessed with reference to the previous day's FF rate (for Monday, 2 May), as published the following morning (Tuesday, 3 May):
(i) daily settlement value for 3 May
   minus
(ii) contract equity that would obtains if the FF rate for 2 May were applied to contract daily settlement value for 2 May, for a term of one business day.

Assuming as before that the FF rate for 2 May 0.09 percent per annum, the mark-to-market is:

$$\begin{matrix}Mark \text{-} to \text{-} Market = - 0.00715 points \\ = ( 3 May Settlement Price ) minus \\ ( 1 + ( 1 / 360 ) ( 0.09 / 100 ) ) \times ( 2 May Settlement Price ) \\ = 89.73905 points minus \\ ( 1 + ( 1 / 360 ) ( 0.09 / 100 ) ) \times 89.74598 points \\ = 89.73905 points minus 89.74620 points\end{matrix}$$

Long open interest holders pay, and short open interest holders collect, variation margin per contract equal to $35.75, equal to 0.00715 points×$5,000 per point.

### Example 9

Finally, suppose that, as in Example 7, above, the contract price is quoted directly in terms of price points, in minimum increments of one quarter of 1/100^{th} of a price point, equal to $12.50 per contract. Then daily settlement prices are as follows:
2 May=89.7450 points
3 May=89.7400 points
The mark-to-market is computed as:

$$\begin{matrix}Mark \text{-} to \text{-} Market = - 0.00522 points \\ = ( 3 May Daily Settlement ) minus \\ ( 1 + ( 1 / 360 ) ( 0.09 / 100 ) ) \times ( 2 May Daily Settlement ) \\ = 89.7400 points minus \\ ( 1 + ( 1 / 360 ) ( 0.09 / 100 ) ) \times 89.7450 points \\ = 89.7400 points minus 89.74522 points\end{matrix}$$

Long open interest holders pay, and short open interest holders collect, variation margin per contract equal to $26.10=0.00522 points×$5,000 per point.

The COBRA futures contract mechanism, if implemented under Simplified Pricing and with Contract Rate quotation, as defined above, may loosely resemble the mechanism embodied in Daily Interest (“DI”) futures listed for trading by the Brazilian futures exchange, Bolsa de Mercadorias e Futuros (now “BVMF”). BVMF first listed DI futures for trading on 5 Jun. 1991.

As was discussed above, the salient features of the BVMF DI futures contract are as follows:

Value basis: The DI Contract value is specified in terms of points, with par equal to 100 points. At termination of trading in a DI futures contract, the contract value is required to equal 100 points. On any date prior to termination of trading, the contract value represents the market participants' assessment of the present value, on that day, of 100 points of contract equity for notional receipt on the bank business day following the contract's last trading day.
Contract reference: The reference from which any DI futures contract derives is a daily sequence of values of the Average One-Day Interbank Deposit Rate (the DI Rate) calculated and published daily by CETIP, a publicly-held Brazilian company that offers registration, custody, trading and settlement of assets and securities. The CETIP interbank deposit is a financial instrument that enables short-term funding transactions among financial institutions. CETIP publishes the DI rate each day.
Pricing engine: The contract value is linked to daily values of the DI Rate as follows:

Pₜ=100×Eₜ[Π_{i=0 . . . M-1}(1+rₜ₊ᵢ/100)^{-bi/252}]
where
Pₜ contract value, in price points, on day t
Eₜ[•] the representative market participant's expectation of the bracketed term, conditional upon information available as of day t
Π( . . . ) product operator where, eg, Π(n₁, n₂, n₃)=n₁×n₂×n₃
M number of BVMF Exchange business days from Day t to the contract's termination of trading
bi the number of Reserves between the two BVMF Exchange business days that follow Day t by i and i+1 Exchange business days, respectively. A Reserve is defined in the DI futures contract terms and conditions to be “a business day for the purpose of operations performed on the financial market, pursuant to the provisions established by the National Monetary Council” of Brazil. To the extent that the BVMF Exchange and the National Monetary Council observe the same schedule of business days, bi's value is typically 1.
rₜ₊ᵢ value of the DI Rate that will apply to a CETIP interbank deposit for settlement on Day t+i and for maturity on the next following Reserve.
   Price quotation: On any given Day t, the DI contract price is quoted in terms of the interest rate per annum, ρₜ that produces contract value Pₜ:

Pₜ=100×((1+ρₜ/100)^{1/252})^{-M}
(To lighten notation, it is assumed that M, the number of BVMF Exchange business days within the interval from Day t until termination of trade in the contract, is equal to the number of National Monetary Council Reserves within the same interval.)

The minimum price increment is 1/10^{th} of one basis point per annum for the nearest three contract expirations and one basis point per annum for all other contracts.

Contract notional size: At termination of trade in a DI futures contract, the contract value is Brz 1,000 per price point, or Brz 100,000 per contract.

Despite similarities between the BVMF DI futures contract and the exemplary embodiments of the COBRA futures mechanism identified above having simplified pricing, the two differ fundamentally in their treatment of yield. Under the terms of the COBRA mechanism, the contract reference interest rate accrues in conformity with standard money market conventions (eg, per Rules 251 and 803 of Rules and Recommendations of the International Capital Markets Association). For example, where the contract reference interest rate, r, accrues over an interval equal to both one calendar day and one business day, on the basis of a 360-day year, the daily rate of accrual is I+(1/360)×(r/100).

By contrast, under the terms of the BVMF Dl futures contract mechanism, the contract reference interest rate accrues according to a money market adaptation of the Braess-Fangmeyer method for computing yield to maturity. That is, under the same circumstances as in the'example above, the daily rate of accrual for the contract reference interest rate would be (1+r/100)^{1/360}.

A distinction of lesser importance concerns the convention by which a year is subdivided for the purpose of compound interest accrual. A peculiar (albeit arbitrary) feature of the BVMF DI futures contract design is that it posits a year divided into 252 purportedly equal intervals. By contrast, the COBRA mechanism encompasses more familiar temporal division schemes, by which a year is partitioned into either 360 or 365 standard money market days.

To appreciate heuristically the differences between the standard money market convention that applies to the COBRA futures contract mechanism and the Braess-Fangmeyer convention that applies to BVMF DI futures discussed above, consider the following idealized examples which compare a hypothetical DI-style contract to a hypothetical COBRA contract implemented under Simplified Pricing as defined above, with Contract Rate quotation, also as defined above. In the following idealized examples, both contracts are assumed to have exactly three years of remaining term to expiration and, in both cases, the contract reference interest rate is assumed to accrue on the basis of a 360-day year.

For the DI-style futures, contract value is determined analogously to the formulation given in above:

P=100/((1+ρ/100)^{1/360})^{(3×360)}

For the COBRA contract, the contract value is determined according to the set-up in described above:

P=100/(1+(1/360)(ρ/100))^{(3×360)}

In both cases, the contract value is determined by daily accrual of the contract-reference interest rate, compounded on each of the 1,080 days remaining until contract expiration (equal to 3 years times 360 days per year). Importantly, for the DI-style future the unit of daily accrual is assumed to be the 360^{th} root of the gross interest rate per annum, or (1+ρ/100)^{1/360}. By contrast, for the COBRA contract the unit of daily accrual is based on the 360^{th} part of the contract interest rate per annum, or 1+(1/360)(ρ/100).

Suppose that at a given moment the contract interest rate, ρ, is equal to 7 percent. For the DI-style futures, the contract value is:

81.6298=100/((1+7/100)^{1/360})^{(3×360)}

For the COBRA contract, the contract value implied by the same contract interest rate is clearly different:

81.0601=100/(1+(1/360)(7/100))^{(3×360)}

Not only do the pricing mechanisms result in different contract value levels for the same contract interest rate. More critical is that the dynamics of contract value—the profits or losses realized by contract holders—arising from the dynamics of the contract interest rate are quite different as between the two mechanisms.

To see this, suppose that a moment later, the contract interest rate, ρ, declines by one basis point per annum to 6.99 percent. For the DI-style futures, the result is an increase in contract value equal to 0.0229 price points:

81.6527=100/((1+6.99/100)^{1/360})^{(3×360)}

For the COBRA contract, the outcome is an increase in contract value contract value equal to 0.0243 price points:

81.0844=100/(1+(1/360)(6.99/100))^{(3×360)}

Suppose both hypothetical contracts were sized at $5,000 per price point. A market participant dealing in the DI-style contract who “buys at 7” and “sells at 6.99” collects variation margin equal to $114.46 per contract, whereas a market practitioner trading the COBRA style contract who likewise has “bought at 7” and “sold at 6.99” collects variation margin equal to $121.58 per contract.

To appreciate in more rigorous terms the differences between the standard money market convention that applies to the COBRA futures contract mechanism and the Braess-Fangmeyer convention that applies to BVMF DI futures discussed above, note that the COBRA futures contract mechanism is erected upon the so-called standard method for computing yield to maturity. See for example, Stigum, Marcia L., and Franklin L. Robinson, Money Market and Bond Calculations, Irwin Professional Publishing, Burr Ridge, Ill., 1996, Chapter 11, or Krgin, Dragomir, Handbook of Global Fixed Income Calculations, John Wiley & Sons, Inc., New York, N.Y., 2002, Chapter 1. The DI futures design, by contrast, utilizes a modification of the Braess-Fangmeyer method, adapted for application to a notional debt instrument paying notional interest every business day. “The Braess-Fangmeyer method appears to be used only in Europe, particularly by domestic investors in the German capital market . . . [It] computes prices and yields on an annual basis, that is, the relevant time interval is taken to be one year. Hence, coupon payments are annual, periodic yields are converted to annual yields before use, and remaining time to maturity is measured in years. This method contrasts to the standard bond equation where all measures are based on a coupon period; that is, coupon payments are per coupon period; yields are compounded at the frequency of payments per year; and time is measured in number of coupon periods remaining.” Stigum, Marcia L., and Franklin L. Robinson, op. cit., pp 281-2. What follows is a comparison of the computational distinctions between these approaches, and a discussion of the advantages of the standard method in application to debt instruments (or futures contracts, or other interest rate derivatives) that reference overnight interest rates, or that make (or make reference to) daily interest payments, or more generally that reference any short-term interest rate for which the term to maturity of such reference interest rate is not meaningfully representable as a fraction of a calendar year.

For any interest-bearing debt instrument, the point of departure for the standard method is the instrument's percentage return per interest payment interval. The instrument's yield per annum is then extrapolated by multiplication. For example, consider a bond paying interest twice per year. The standard method takes as given the bond's percentage return per semester yₛ and translates this to a yield per annum y by multiplying it by the number of semesters per year:

y=2×yₛ

The converse is accommodated easily and naturally. That is, given the bond's yield per annum, the standard method identifies the percentage return for each semester as half the annual percentage rate:

yₛ=y/2

Similarly, consider a money market placement paying interest on each business day. Suppose that over a normal weekend—with settlement on Friday, and repayment of principal with interest on the following Monday, and where neither Saturday nor Sunday is a business day—the placement pays an interest percentage equal to yₛ. Suppose moreover that market convention calls for one year to be normalized as 365 days (e.g., as in the UK or Japan). Under these conditions, the standard method finds the corresponding yield per annum by multiplying yₛ by the number of 3-day intervals within a 365-day year:

y=(365/3)×yₛ

Again the converse is straightforward. Given the yield per annum y, the percentage return for the 3-day holding period (Friday to following Monday) is

yₛ=(3/365)×y.

The point of departure for the Braess-Fangmeyer method is the debt instrument's yield per annum y. The Braess-Fangmeyer approach purports to distribute this yield to the instrument's periodic interest payment periods, such that the process of periodic reinvestment and compounding of interest recovers the annual yield. E.g., for a bond paying interest twice per year, the percentage rate of return per semester would be set as:

y_{b}=(1+y)^{1/2}−1

The yield per annum would be recovered as:

y=(1+y_{b})²−1

Similarly, for a money market placement paying interest over a normal weekend at a given yield per annum y (again presuming a standard 365-day year), the Braess-Fangmeyer method would impute the percentage return over the three-day holding period as:

y_{b}=(1+y)^{3/365}−1

These examples highlight two comparative failings of the Braess-Fangmeyer approach.

Computational Inefficiency:

Even in its most basic guise, the Braess-Fangmeyer method entails two to three times greater computational effort than the standard method.

To see this, consider first the linkage between yield per annum y and periodic percentage interest payment yₛ under the standard method. Assume an integer number n of regular interest payments per year (eg, n=4 if quarterly, n=2 if semiannually). For a given yield per annum, the linkage is yₛ=(1/n)×y. Making the transit requires two operations—one division and one multiplication. Conversely, for a given percentage payment per interest period the linkage is y=n×yₛ, requiring just one operation, a multiplication, to execute.

Now consider the corresponding Braess-Fangmeyer relationships. For a given yield per annum y the linkage is y_{b}=(1+y)^{1/n}−1. The transformation from y to y_{b}, the percentage payment per interest period, requires four operations—one addition, one division, one exponentiation, and one subtraction—rather than two. Conversely, for a given percentage payment per interest period y_{b} the linkage is y=(1+y_{b})ⁿ−1. Making the return transit requires three operations—one addition, one exponentiation, and one subtraction—in place of one.

Rigidity, Time Value of Money, and Fictive Compounding of Interest;

The Braess-Fangmeyer method is inferior to the standard method in terms of both clarity of interpretation and flexibility. The reason is that, with the exception of debt instruments that pay interest annually (for which it is ideally suited), the Braess-Fangmeyer approach entails the pretense that a debt instrument's schedule of interest payments is aligned identically with the schedule on which the borrower and lender recognize the time value of money.

To see this, it is useful to begin by noting that the standard method's computation reflects, by construction, the amounts and the timing of the cash flows of the debt instrument to which it is applied. For this reason it produces rates of return that are comparatively simpler for the user to apprehend, to interpret, and to compare against alternatives. To appreciate the point, consider a money market placement that pays interest at a given yield per annum y, with interest paid on each business day. As before, a year is assumed to be standardized to 365 days. If settlement is assumed to be on Friday, with redemption of principal on the following Tuesday, then the standard method would impute the percentage return yₛ for the placement's 4-day holding period as:

yₛ={(1+(3/365)×y)×(1+(1/365)×y)}−1

Important to note is that the linkage reflects, transparently and usefully, the details and financial impact of the timing of interest payments and the reinvestment of those interest payments. If, for instance, settlement were to occur instead on Monday with repayment of principal four business days later on the following Friday, then the determination of the 4-day holding period return would properly reflect the material differences that arise from interest being paid, reinvested, and compounded on each day of the holding period:

yₛ=(1+(1/365)×y)⁴−1

Confronted with the same fact patterns, the user of the Braess-Fangmeyer method is compelled to adopt one of two counterfactual approximations to translate from yield per annum to the percentage interest payment over the 4-day holding period. Both approximations destroy financially consequential information that the standard method preserves:
(a) On one hand, the Braess-Fangmeyer user may implement the method with the assumption that interest is (fictively) paid on each of the year's 365 days instead of on each business day. By this accommodation, the linkage between the percentage return over a 4-day holding period is the same, irrespective of whether the holding period runs from a Friday to a Tuesday, or from a Monday to a Friday:

y_{b}=(1+y)^{4/365}−1
In other words, this computation fails to capture the material distinction between payment of simple interest (without compounding) over the non-working weekend days that enter into the Friday-to-Tuesday instance, versus payment of interest on each day in the Monday-to-Friday instance; and
(b) Alternatively, the user may implement the method with the seemingly more plausible assumption that interest is paid—and the passage of time is thereby measured—only on business days. (For convenience, let's assume that a standard year contains 252 business days.) According to this accommodation, the resultant linkage for a 4-day money market placement held from Monday to the following Friday looks sensible:

y_{b}=(1+y)^{4/252}−1.

The reason is that the number of calendar days encompassed by the placement's holding period is conveniently identical to the number of business days on which interest is paid.

More troubling is the linkage that emerges for the money market placement held from Friday to the following Tuesday:

y_{b}=(1+y)^{2/252}−1

Although the holding period remains the same, at 4 calendar days, the percentage interest payment is considerably less, reflecting that only two business days have elapsed. In effect, this implementation places the Braess-Fangmeyer user in the undesirable position of being unable to ascribe time value of money to the weekend days that are bracketed by the holding period.

This latter “business day” accommodation is precisely what the BVMF exchange adopted in 1991 to implement the design of its DI futures contract. (As in the preceding example, there are presumed to be 252 Brazilian central bank business days per year). That is, to achieve the notional financial effect of daily compounding of interest, the DI futures contract design requires that contract users maintain the inconvenient fiction that the time value of money is zero over weekend days and central bank holidays.

The salient features of the BVMF DI futures contract were discussed above. Among the DI contract's prominent features is that its price is quoted in terms of the interest rate value ρ which, if compounded daily from contract trade date until contract expiration, equates to the return that market participants expect to be generated by daily compounding of the CETIP deposit rate over the same interval. An implication of this price quoting convention is that the pecuniary value attached to a given quoted “price” increment is almost certain to vary, for any single futures contract, depending upon the level of the contract's reference interest rate and/or the interval of time until the contract expires.

The following examples illustrate. Consider a DI futures contract with exactly two years (ie, 504 Brazilian National Monetary Council business days) until expiry, for which contract “price” is quoted in minimum increments of one interest rate basis point per annum. The relationship between the contract interest rate (in terms of which price is quoted) and the contract value (in terms of which daily marks to market are collected from and/or paid to contract holders) is as follows:

P=100×(1+ρ/100)⁻²=100×((1+ρ/100)^{1/252})⁻⁵⁰⁴

Suppose the contract is priced at ρ equal to 10 percent per annum. Given that contract notional size is Brz 100,000, i.e., 100,000 Brazilian reais per contract, the implied contract value is:

Brz 82,644.33=Brz 100,000×(1+10/100)⁻²

At this price level, the value of a contract “tick”—the change in contract value (up or down) for a one-basis-point change in the quoted contract price (down or up)—is Brz 15.03, i.e., 15.03 Brazilian reais per contract.

Now suppose contract price abruptly drops to 5 percent per annum. Contract value jumps accordingly to:

Brz 90,792.95=Brz 100,000×(1+5/100)⁻²

Importantly, at this new price level the value of a contract tick is no longer Brz 15.03, but rather Brz 17.28.

Next suppose that one year later the contract price remains 5 percent per annum. Because the contract has one year of life remaining until its expiry, rather than two, its value has risen to:

Brz 95,238.10=Brz 100,000×(1+5/100)⁻¹

Moreover, despite no nominal change in the contract price, the value of a contract tick is no longer Brz 17.28, but rather Brz 9.07.

In contrast, the COBRA futures contract, in an embodiment wherein price is quoted in terms of points and/or fractions of points of contract value as defined above with respect to “price quotation” of the COBRA futures contract, is defined so that the pecuniary value of the contract minimum price increment is always fixed, irrespective of the level of the contract reference interest rate and irrespective of the time remaining until contract expiration.

It will be appreciated that for either COBRA futures contracts or DI futures contracts, the magnitude of response of contract value to a given interest rate change, e.g., the absolute magnitude of change in contract equity value produced by an interest rate movement of one basis point per annum (or PV01), is almost certain to shrink as the contract term to expiration shrinks.

A direct implication is that for a DI futures contract, where price is quoted and traded in terms of the contract interest rate, or for any embodiment of the COBRA contract wherein price is quoted in terms of contract interest rate, the PV01 is almost certain to shrink as term to contract expiry shrinks.

By contrast, for any embodiment of the disclosed COBRA futures contract wherein prices are quoted and traded directly in terms of increments of contract equity, the contract “tick” is fixed by construction, as one of the futures contract terms and conditions. The contract holder may reap or lose a greater or smaller number of ticks for any given move in the contract interest rate, depending on market conditions and/or term to contract expiry. But the pecuniary value of the “tick” itself holds constant.

With respect to the DI contract, the inherent variability of the contract tick would require a futures clearing house to re-compute this value, quite likely several times each day, in order to monitor the risks being borne by contract open interest holders.

The same would apply to any futures exchange market regulatory team charged with performing market surveillance in connection with traffic in such contracts.

The same would apply to any market participant engaged in trading such contracts.

The variable tick feature would pose a particularly serious challenge to market makers and other high-frequency traders who, in the natural course of business, would enter or exit positions at numerous different times and contract price levels within a given trading session. Especially in “fast market” conditions, when contract prices are highly volatile from moment to moment, the variable tick feature would impede rapid and accurate position risk management.

With the signal exception of the DI contract, successful and highly-traded short-term interest rate futures contracts have been designed specifically to avoid this difficulty. For a CME Eurodollar futures contract, to take a notable example, the contract terms and conditions specify that a one-basis-point movement in the contract reference interest rate is always associated with a $25 movement of variation margin monies, regardless of either the market level of the contract reference interest rate or the interval of time remaining until the contract expires.

Assuming hypothetically that there were no DI futures contract, the points given above would almost certainly stand in the way of a successful de novo launch of such contracts. The DI futures suite thrives today in spite of the inconveniences of its contract design, not because of them. Brazilian money market practitioners have had more than 20 years to become familiar with the idiosyncrasies of the contract structure and to develop back-office accounting software, trading techniques, and—with substantial assistance from the BVMF exchange—trading position management technology to accommodate the quirks of contract design. None of this apparatus holds out much promise of cost-effective portability or application to money market derivatives beyond Brazil.

Against this backdrop, one of the comparative virtues of the COBRA futures mechanism (in its Price Point Quotation embodiments) is that it ensures a fixed contract tick value. This in turn would be expected to conduce to the introduction and adoption of the COBRA mechanism in derivatives markets where market infrastructure and trading practices would are likely to be resistant to contracts exhibiting the variable tick feature.

The COBRA futures contract mechanism, in an embodiment which utilizes the Exact Pricing convention defined above and with Contract Rate price quotation as defined above, observes the practices that apply to pricing of standard OIS (as per, eg, EUR-EONIA-OIS-COMPOUND or USD-Federal Funds-H.15-OIS-COMPOUND definitions enshrined in the International Swaps and Derivatives Association Definitions).

This embodiment of the COBRA futures contract mechanism may be fundamentally distinguishable from OIS in at least two ways. One is mode of transaction. A COBRA futures contract mechanism is posited as a standardized commodity futures contract, to be listed for trading as such in a competitive and centralized market, with a daily mark-to-market transparently determined by the designated contract market on which it is listed for trading, subject to all federal law and regulation that apply to exchange-listed futures contracts.

By contrast, OIS currently are dealt only in over-the-counter markets. If and when the applicable provisions of the Dodd-Frank Wall Street Reform and Consumer Protection Act of 2009 (DFA) have been implemented, the most highly standardized varieties of US dollar-denominated OIS would be required to trade either on swap execution facilities or in futures-style centralized limit order book markets. The crucial distinction is that trading of OIS will be subject to federal law and regulation bearing upon swap transactions, and not law and regulation pertaining to futures transactions.

The other point of distinction is central counterparty guarantee. As with any other futures contract, COBRA futures would be guaranteed by a clearing house that stands in its traditional role as the buyer to each contract seller and the seller to each contract buyer.

OIS, for now, are not required to bear the guarantee of a centralized counterparty. As above, if and when the pertinent titles of DFA have been implemented, many if not all OIS contracts will require the guarantee of a centralized counterparty (albeit at levels of performance bond levels that will be considerably higher than performance bond requirements that would apply to a COBRA futures contract). Here too, the pivotal distinction is that OIS contracts, sui generis, will be subject to federal law and regulation concerning centralized clearing of swaps, whereas the corresponding COBRA futures contract will be subject to federal law and regulation pertaining to centralized clearing of futures.

Supporters and critics alike observe that both CBOT Interest Rate Swap futures and Liffe Swapnote futures (under current contract terms and conditions) are handicapped by their inability to “roll down the curve” similar to interest rate swaps. The COBRA futures contract mechanism, by contrast, gives users term-to-maturity exposure that shortens naturally with the passage of time, i.e., natural amortization.

In addition, as observed above, among the leading candidates for underlying reference for COBRA futures contracts would be overnight interbank interest rate benchmarks such as the US daily effective federal funds rate (FF), Eonia, and/or Sonia. Because these are computed as trade-volume-weighted averages, they might hold greater appeal, e.g. perceived integrity, to short-term interest rate futures users who are skeptical of the integrity of survey-based interest rate measures.

Further, FF or Eonia implementations of the COBRA futures contract mechanism would make useful ancillaries to Libor-reference and EURIBOR-reference IRS (including, eg, CME Cleared IRS) that are subject to OIS valuation. An overnight BBA Libor implementation would fill the need for “stub rate” futures to use in conjunction with the Eurodollar futures strip.

The COBRA futures contract structure also would conduce to rich arrays of expiration days that coincide with key periodic dates in both established futures markets and cash government bond markets (eg, IMM dates to match Eurodollar and/or Euribor futures, month-end and/or 15th of month to match Treasury Note coupon and maturity dates, first business days and/or last business days of Treasury futures delivery months).

With the exception of the BVMF DI futures suite, the COBRA futures mechanism is unlike any futures contract design currently listed for trading on any major contract market, including any CMEG DCMs, or Liffe, or Eurex.

Consider a COBRA-style futures contract for a given expiration date, and for which contract price is quoted in terms of Contract Rate, as described and as exemplified above. The magnitude of change in contract value for any given change in contract interest rate will tend to shrink with passage of time, in tandem with shrinking term-to-maturity exposure embedded in the contract. This would necessitate extensive and costly build-out of risk management and trade processing platforms used by middle and back offices of potential contract users. The same would apply to the market dominant service bureaus that vend automated back-office management applications to futures commission merchants and brokerages.

However, this commercial handicap would not apply to embodiments of COBRA futures contract mechanism for which contract price is quoted directly in terms of Price Points, as described and as exemplified above. In this embodiment, the contract minimum price increment is fixed, rather than variable.

As observed in the introduction, unlike most familiar STIR or cash-settled fixed-income futures, a COBRA futures contract does not converge to a single final settlement price at termination of trading. Instead, it undergoes a definitive settlement price evaluation on each business day—“definitive” by virtue of explicit reference to the contract's underlying reference interest rate. This feature of the contract mechanism might therefore place correspondingly higher burden upon the reliability and operational robustness with which the listing exchange and/or clearing house establishes daily settlement prices and daily marks-to-market.

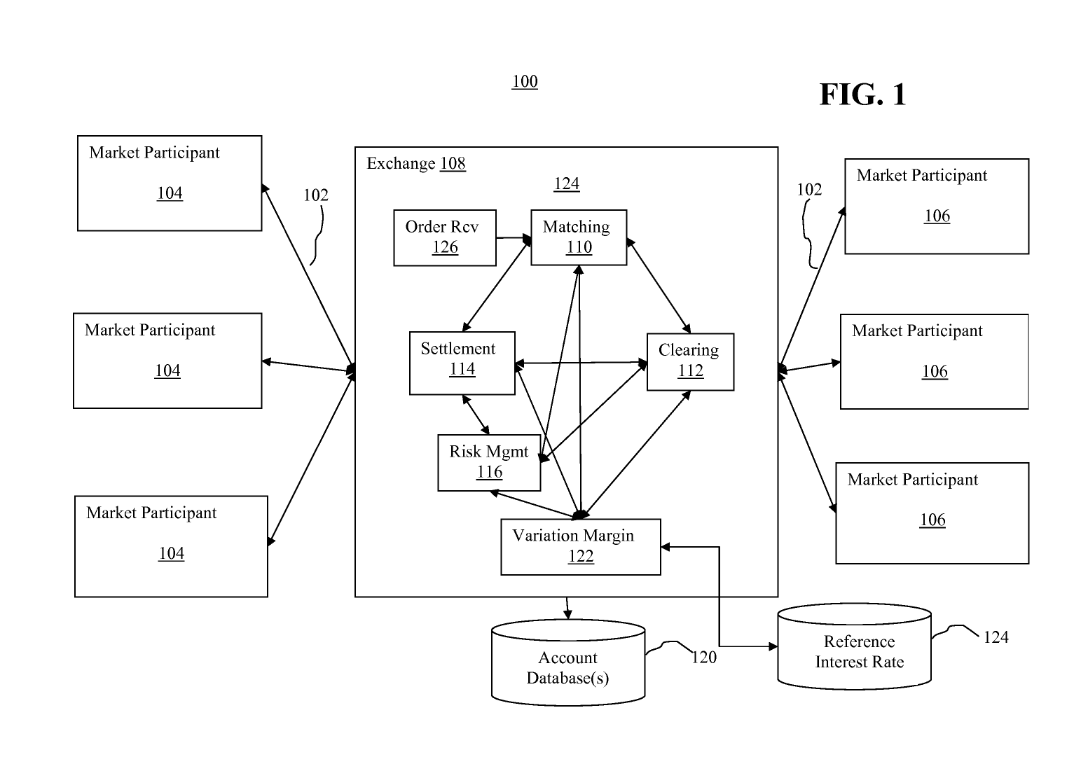

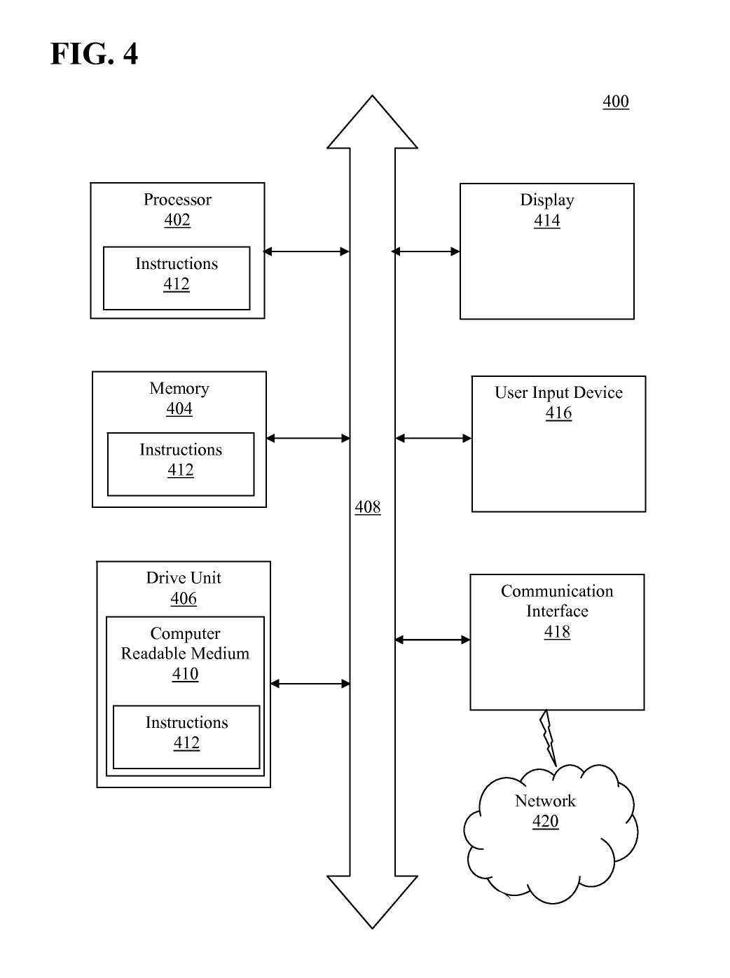

Referring now to FIG. 1, there is shown a block diagram of an exemplary network 100 for trading futures contracts, including in which futures contracts, such as COBRA futures contracts, may be implemented, according to the disclosed embodiments. The network 100 couples market participants 104, 106, such as traders 104 and market makers 106, with an exchange 108, such as the CME, also referred to as a central counterparty or intermediary, via a communications network 102, such as the Internet, an intranet or other public or private, secured or unsecured communications network or combinations thereof such as the network 420 described below with respect to FIG. 4. The network 100 may also be part of, or alternatively coupled with a larger trading network, allowing market participants 104 106 to trade products, such as futures contracts, options contracts, foreign exchange instruments, etc., via the exchange 108, including COBRA futures contracts as described herein. It will be appreciated that the plurality of entities utilizing the disclosed embodiments, e.g. the market participants 104, 106, may be referred to by other nomenclature reflecting the role that the particular entity is performing with respect to the disclosed embodiments and that a given entity may perform more than one role depending upon the implementation and the nature of the particular transaction being undertaken, as well as the entity's contractual and/or legal relationship with another market participant 104 106 and/or the exchange 108.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The exchange 108 implements the functions of matching 110 buy/sell transactions, clearing 112 those transactions, settling 114 those transactions and managing risk 116 among the market participants 104 106 and between the market participants and the exchange 108, which includes calculation and management of variation margin 122. The exchange 108 may include or be coupled with one or more database(s) 120 or other record keeping system which stores data related to open, i.e. un-matched, orders, matched orders which have not yet been delivered, or other data, or combinations thereof. Further, the exchange 108, or the variation margin functionality 122 thereof, may be further coupled with a reference interest rate source 124 as will be further described below.

Typically, the exchange 108 provides a “clearing house” (not shown) which is a division of the Exchange 108 through which all trades made must be confirmed, matched and settled each day until offset or delivered. The clearing house is an adjunct to the Exchange 108 responsible for settling trading accounts, clearing trades, collecting and maintaining performance bond funds, regulating delivery and reporting trading data. The clearing house essentially mitigates credit risk. Clearing is the procedure through which the Clearing House becomes buyer to each seller of a futures contract, and seller to each buyer, also referred to as a “novation,” and assumes responsibility for protecting buyers and sellers from financial loss by assuring performance on each contract. This is effected through the clearing process, whereby transactions are matched. A clearing member is a firm qualified to clear trades through the Clearing House.

As used herein, the term “Exchange” 108 will refer to the centralized clearing and settlement mechanisms, risk management systems, etc., as described below, used for futures trading. In the presently disclosed embodiments, the Exchange 108 assumes an additional role as the central counterparty in futures contract, such as COBRA futures contracts, computing daily settlement prices for the purposes of determining, among other parameters, variation margin for such contracts.

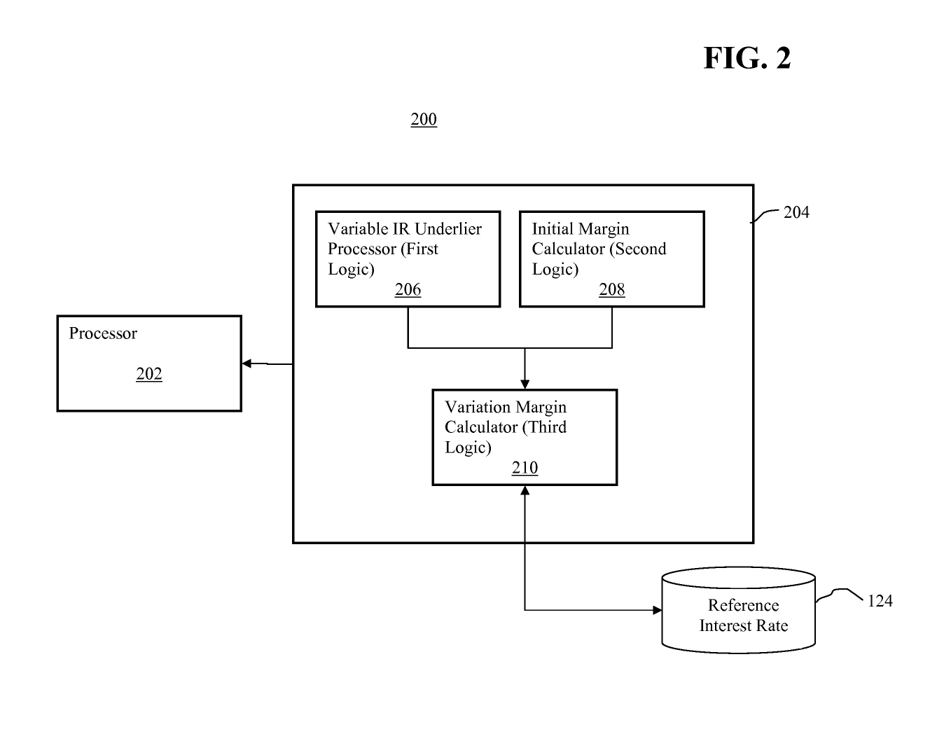

Referring to FIG. 2, a system 200 for minimizing a number of transactions in a central counterparty based exchange necessary to manage exposure to risk of interest rate change as was described above. It will be appreciated that the system 200 may be a part of the Risk Management 116 and/or Variation Margin 122 functionality of the exchange 108. The system 200 includes a processor 202 and a memory 204 coupled therewith. The system further includes a variable interest rate interest bearing underlier processor 206, which may be implemented as first logic stored in the memory 204 and executable by the processor 202, which allows a position holder, e.g. a trader, to take a position, either by buying or selling, in a futures contract having an underlier bearing a variable interest rate, the futures contract being characterized by a price and a final settlement date. The system 200 further includes an initial margin calculator 208, which may be implemented as second logic stored in the memory 204 and executable by the processor 202, coupled with the variable interest rate interest bearing underlier processor 206 and which computes an initial margin requirement for the position in the futures contract representative of the risk of loss by the position holder associated with the futures contract position. The system 200 further includes a variation margin calculator 210, which may be implemented as third logic stored in the memory 204 and executable by the processor 202, coupled with the variable interest rate interest bearing underlier processor 206 and the initial margin calculator 208 and which computes, periodically, such as daily, weekly, etc., a variation margin representative of a change in the risk of loss over a most recently ended prior period, the variation margin being computed as a function of a reference variable interest rate for the interest bearing underlier, wherein the function comprises an accounting of a timing, and reinvestment, of notional interest payments specified by the underlier over all business and non-business days of the most recently ended prior period.

In one embodiment, the variation margin is computed at an end of each business day. Further, the function according to which the variation margin is computed may account for a time value of money over any non-business days between a most recent previous computation of the variation margin and the business day when the variation margin is computed. Alternatively, or in addition thereto, the function according to which the variation margin is computed may account for simple interest paid on non-business days and compounded interest paid on business days preceding the computation of the variation margin.

In one embodiment, the reference interest rate may be obtained, such as via a network, from a reference interest rate source, which may comprise a database or service, such as a daily effective federal funds (FF) rate published by Federal Reserve Bank of New York, a Eurozone overnight index average (Eonia) published by the European Central Bank, a central securities depository rate for Sistema Especial de Liquidação e Custodia (the SELIC rate) published by Banco Central do Brasil, an Average One-Day Interbank Deposit Rate (the CETIP or DI rate) calculated and published daily by CETIP, a publicly-held Brazilian company that offers registration, custody, trading and settlement of assets and securities, an overnight London Interbank Offered Rate (LIBOR) sponsored by the British Bankers' Association, a sterling overnight index average (Sonia) sponsored by Wholesale Market Brokers' Association, an overnight Tokyo Interbank Average Rate (TIBOR) sponsored by Zenginkyo, the Japan Bankers' Association, a 1-week Main Refinancing Operations Rate administered by the European Central Bank, an 1-week London Interbank Offered Rate (LIBOR) sponsored by the British Bankers' Association, a 1-week European Interbank Offered Rate (Euribor) sponsored by the European Banking Federation, a 1-week Tokyo Interbank Average Rate (TIBOR) sponsored by Zenginkyo, the Japan Bankers' Association, or combinations thereof.

In one embodiment, the price of the position in the futures contract in the market therefore may diverge from the reference variable interest rate over time.

In one embodiment, the final settlement date may be at least 6 months after a date of purchase of the futures contract.

In one embodiment, the variable interest bearing underlier may be further characterized by a term to maturity which decays over time.

In one embodiment, a periodic settlement price, computed on any date prior to the termination of trading in the futures contract, is computed based on the reference variable interest rate for the underlier, the daily settlement price being different from the price of the futures contract in the market therefore on the settlement date.

In one embodiment, a final settlement price computed at the final settlement date may be computed based on the reference variable interest rate for the underlier, the final settlement price being a difference from the price of the futures contract in the market therefore on the final settlement date.

In one embodiment, the price of the futures contract at the final settlement date may be defined as 100 price points.

In one embodiment, the futures contract is characterized by a compound accrual of a daily interest rate up to the final settlement date.

In one embodiment, the risk of loss may be representative of notional exposure to the variable interest bearing underlier.

In one embodiment, the price of the futures contract is quoted in increments of contract value, wherein the pecuniary value of the minimum allowable increment in a quoted contract price is fixed.

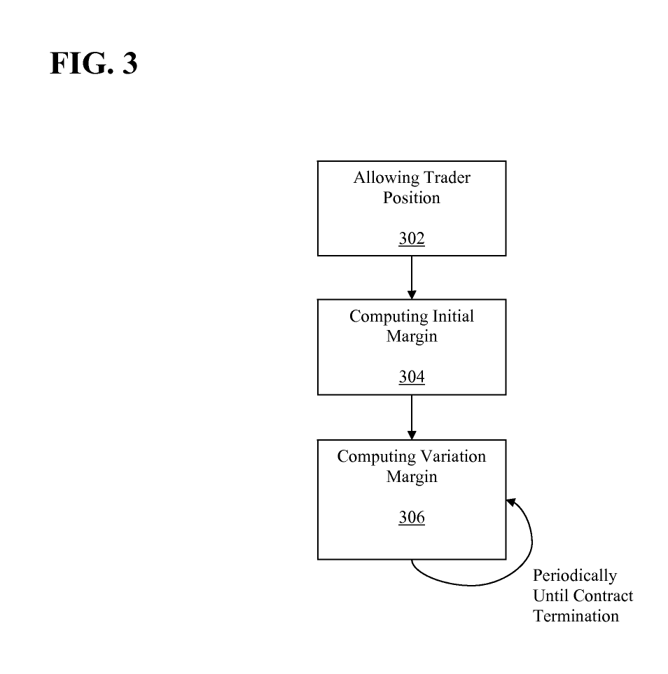

FIG. 3 depicts a flow chart showing operation of the system of FIGS. 1 and 2. In particular FIG. 3 shows a computer implemented method of minimizing a number of transactions in a central counterparty based trading system necessary to manage exposure to risk of interest rate change. The operation of the system 200 includes: allowing, by a processor, a position holder, e.g. a trader, to take a position, e.g. by buying or selling, in a futures contract having an underlier bearing a variable interest rate, the futures contract being characterized by a price and a final settlement date (block 302); computing, by the processor, an initial margin requirement for the position in the futures contract representative of the risk of loss by the position holder associated with the futures contract position (block 304); and computing, by the processor, periodically, e.g. daily, weekly, etc., a variation margin representative of a change in the risk of loss over a most recently ended prior period, the variation margin being computed as a function of a reference variable interest rate for the interest bearing underlier, wherein the function comprises an accounting of a timing, and reinvestment, of notional interest payments specified by the underlier over all business and non-business days of the most recently ended prior period (block 306).

In one embodiment, the variation margin is computed at an end of each business day. Further, the function according to which the variation margin is computed may account for a time value of money over any non-business days between a most recent previous computation of the variation margin and the business day when the variation margin is computed. Alternatively, or in addition thereto, the function according to which the variation margin is computed may account for simple interest paid on non-business days and compounded interest paid on business days preceding the computation of the variation margin.

In one embodiment, the reference interest rate may be obtained, such as via a network, from a reference interest rate source, which may comprise a database or service, such as a daily effective federal funds (FF) rate published by Federal Reserve Bank of New York, a Eurozone overnight index average (Eonia) published by the European Central Bank, a central securities depository rate for Sistema Especial de Liquidação e Custodia (the SELIC rate) published by Banco Central do Brasil, or combinations thereof.

In one embodiment, the price of the position in the futures contract in the market therefore may diverge from the reference variable interest rate over time.

In one embodiment, the final settlement date may be at least 6 months after a date of purchase of the futures contract.

In one embodiment, the variable interest bearing underlier may be further characterized by a term to maturity which decays over time.

In one embodiment, a periodic settlement price, computed on any date prior to the termination of trading in the futures contract, is computed based on the reference variable interest rate for the underlier, the periodic settlement price being different from the price of the futures contract in the market therefore on the settlement date.

In one embodiment, a final settlement price computed at the final settlement date may be computed based on the reference variable interest rate for the underlier, the final settlement price being a difference from the price of the futures contract in the market therefore on the final settlement date.

In one embodiment, the price of the futures contract at the final settlement date may be defined as 100 price points.

In one embodiment, the futures contract is characterized by a compound accrual of a daily interest rate up to the final settlement date.

In one embodiment, the risk of loss may be representative of notional exposure to the variable interest bearing underlier.

In one embodiment, the price of the futures contract is quoted in increments of contract value, wherein a pecuniary value of the minimum allowable increment in a quoted contract price is fixed.

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above, such as the processor 202, may be a computer system 400 or a component in the computer system 400. The computer system 400 may implement a match engine, margin processing, payment or clearing function on behalf of an exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include a disk or optical drive unit 406. The disk drive unit 406 may include a computer-readable medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

What is claimed is:

1. A computer implemented method of minimizing a number of transactions in a central counterparty based trading system necessary to manage exposure to risk of interest rate change, the method comprising:
allowing, by a processor, a position holder to take a position in a futures contract having an underlier bearing a variable interest rate, the futures contract being characterized by a price and a final settlement date;
computing, by the processor, an initial margin requirement for the position in the futures contract representative of the risk of loss by the position holder associated with the futures contract position; and
computing, by the processor, periodically, a variation margin representative of a change in the risk of loss over a most recently ended prior period, the variation margin being computed as a function of a reference variable interest rate for the interest bearing underlier, wherein the function comprises an accounting of a timing, and reinvestment, of notional interest payments specified by the underlier over all business and non-business days of the most recently ended prior period.

2. The computer implemented method of claim 1 wherein the variation margin is computed at an end of each business day.

3. The computer implemented method of claim 2 wherein the function accounts for a time value of money over any non-business days between a most recent previous computation of the variation margin and the business day when the variation margin is computed.

4. The computer implemented method of claim 2 wherein the function accounts for simple interest paid on non-business days and compounded interest paid on business days preceding the computation of the variation margin.

5. The computer implemented method of claim 1 wherein the reference interest rate comprises a daily effective federal funds (FF) rate published by Federal Reserve Bank of New York, a Eurozone overnight index average (Eonia) published by the European Central Bank, a central securities depository rate for Sistema Especial de Liquidação e Custodia (the SELIC rate) published by Banco Central do Brasil, or combinations thereof.

6. The computer implemented method of claim 1 wherein the price of the position in the futures contract in the market therefore diverges from the reference variable interest rate over time.

7. The computer implemented method of claim 1 wherein the final settlement date is at least 6 months after a date of purchase of the futures contract.

8. The computer implemented method of claim 1 wherein the variable interest bearing underlier is further characterized by a term to maturity which decays over time.

9. The computer implemented method of claim 1 where a periodic settlement price, computed on any date prior to the termination of trading in the futures contract, is computed based on the reference variable interest rate for the underlier, the periodic settlement price being different from the price of the futures contract in the market therefore on the settlement date.

10. The computer implemented method of claim 9 wherein the price of the futures contract at the final settlement date is defined as 100 price points.

11. The computer implemented method of claim 1 wherein the futures contract is characterized by a compound accrual of a daily interest rate up to the final settlement date.

12. The computer implemented method of claim 1 wherein the risk of loss is representative of notional exposure to the variable interest bearing underlier.

13. The computer implemented method of claim 1 wherein the price of the futures contract is quoted in increments of contract value, wherein the pecuniary value of the minimum allowable increment in a quoted contract price is fixed.

14. A system for minimizing a number of transactions in a central counterparty based exchange necessary to manage exposure to risk of interest rate change, the system comprising a processor and a memory coupled therewith, the system further comprising:
first logic stored in the memory and executable by the processor to allow a position holder to take a position in a futures contract having an underlier bearing a variable interest rate, the futures contract being characterized by a price and a final settlement date;
second logic stored in the memory and executable by the processor to compute an initial margin requirement for the position in the futures contract representative of the risk of loss by the position holder associated with the futures contract position; and
third logic stored in the memory and executable by the processor to compute, periodically, a variation margin representative of a change in the risk of loss over a most recently ended prior period, the variation margin being computed as a function of a reference variable interest rate for the interest bearing underlier, wherein the function comprises an accounting of a timing, and reinvestment, of notional interest payments specified by the underlier over all business and non-business days of the most recently ended prior period.

15. The system of claim 14 wherein the variation margin is computed at an end of each business day.

16. The system of claim 15 wherein the function accounts for a time value of money over any non-business days between a most recent previous computation of the variation margin and the business day when the variation margin is computed.

17. The system of claim 15 wherein the function accounts for simple interest paid on non-business days and compounded interest paid on business days preceding the computation of the variation margin.

18. The system of claim 14 wherein the reference interest rate comprises a daily effective federal funds (FF) rate published by Federal Reserve Bank of New York, a Eurozone overnight index average (Eonia) published by the European Central Bank, a central securities depository rate for Sistema Especial de Liquidação e Custodia (the SELIC rate) published by Banco Central do Brasil, or combinations thereof.

19. The system of claim 14 wherein the price of the position in the futures contract in the market therefore diverges from the reference variable interest rate over time.

20. The system of claim 14 wherein the final settlement date is at least 6 months after a date of purchase of the futures contract.

21. The system of claim 14 wherein the variable interest bearing underlier is further characterized by a term to maturity which decays over time.

22. The system of claim 14 where a periodic settlement price, computed on any date prior to the termination of trading in the futures contract, is computed based on the reference variable interest rate for the underlier, the periodic settlement price being different from the price of the futures contract in the market therefore on the settlement date.

23. The system of claim 22 wherein the price of the futures contract at the final settlement date is defined as 100 price points.

24. The system of claim 14 wherein the futures contract is characterized by a compound accrual of a daily interest rate up to the final settlement date.

25. The system of claim 14 wherein the risk of loss is representative of notional exposure to the variable interest bearing underlier.

26. The system of claim 14 wherein the price of the futures contract is quoted in increments of contract value, wherein the pecuniary value of the minimum allowable increment in a quoted contract price is fixed.

27. A system for minimizing a number of transactions in a central counterparty based exchange necessary to manage interest rate change exposure, the system comprising:
means for allowing a position holder to take a position in a futures contract having an underlier bearing a variable interest rate, the futures contract being characterized by a price and a final settlement date;
means for computing an initial margin requirement for the position in the futures contract representative of the risk of loss by the position holder associated with the futures contract position; and
means for computing periodically, a variation margin representative of a change in the risk of loss over a most recently ended prior period, the variation margin being computed as a function of a reference variable interest rate for the interest bearing underlier wherein the function comprises an accounting of a timing, and reinvestment, of notional interest payments specified by the underlier over all business and non-business days of the most recently ended prior period.
